(19) United States
(12) Patent Application Publication
(10) Pub. No.: US 2007/0132878 A1
(43) Pub. Date: Jun. 14, 2007

(54) Digital camera system

(75) Inventor: Hiroshi Tanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/637,765

(22) Filed: Dec. 13, 2006

(30) Foreign Application Priority Data
Dec. 13, 2005 (JP) 2005-359376

(51) Int. Cl. H04N 5/225

(52) U.S. Cl. 348/360

(57) ABSTRACT

One of plural lens units is selectively attached to a camera body. An image signal output from a CCD is converted into CCD RAW data in an A/D converter, and then converted into YC data in a digital signal processing section. The YC data is sent to the camera body and written in a memory. A camera system controller reads the YC data from the memory. The YC data is resized to generate a thumbnail image. The thumbnail image, and a principal image reproduced from the entire YC data are compressed in JPEG format. The compressed data, and tag information are written in a memory card as an image file. The lens unit generates a RAW file having CCD RAW data. When the RAW file is selected, the RAW file is sent to the camera body and written in the memory card without being subjected to image processing.

### FIELD OF THE INVENTION

The present invention relates to a digital camera system with exchangeable lens units.

### BACKGROUND OF THE INVENTION

A digital camera system in which one of various types of lens units is selected and detachably attached to a camera body is known. For instance, Japanese Patent Laid-Open Publication No. 2000-175089 discloses a digital camera of a lens unit exchangeable type in which one of exchangeable lens units is detachably attached to a camera body. Signals are transmitted and received between the attached lens unit and the camera body via a connector. Each lens unit has a taking lens, an image sensor, and a ROM in which a control program for controlling an MPU is stored. The camera body has a relatively expensive image signal processing circuit, the MPU, recording media, and the like. The MPU receives the control program and other data unique to the attached lens unit from the ROM and an EEPROM in the attached lens unit, and controls image processing in the image signal processing circuit based on the received program and data.

A digital camera disclosed in U.S. Pat. No. 6,707,490 is constituted of an image-capturing section and a camera body. The image-capturing section includes a taking lens and an image sensor. The camera body includes an image processing section in which electrical signals from the image sensor are processed. One of various types of image-capturing sections is selected, and detachably attached to the camera body. By exchanging the image-capturing section, the optimum combination of the taking lens and the image sensor can be selected in accordance with the subject.

A digital camera disclosed in Japanese Patent No. 3184187 includes image-capturing sections each of which is provided with a storage unit. In the storage unit, image sensor specification information such as pixel number information and color filter information of the image sensor are stored. It ensures appropriate signal processing by the processing section of the camera body even when the image-capturing section is exchanged. The image-capturing section having an appropriate image sensor size or an appropriate color filter arrangement is selected according to purposes. For instance, when image quality is in top priority, an image-capturing section with a large number of pixels is used, or when cost is top priority, an image-capturing section with a small number of pixels is used. In such cases, the processing section in the camera body receives the pixel number information of the image sensor from the image-capturing section, and appropriate processing is thus performed.

A video camera disclosed in U.S. Pat. No. 6,414,714 is constituted of a video camera body and an imaging block. The video camera body has a signal processing device which processes image signals from an image sensor, and outputs video signals. The imaging block having the image sensor is detachably attached to the video camera body. The imaging block has a memory device in which setup data for setting up the video camera is stored. The video camera body has a controlling device which sets up the imaging block and the video camera body based on the setup data stored in the memory device.

The above cameras necessitate the lens unit to send various parameters unique to the lens unit such as the pixel number information, the color filter information, and the setup data to the camera body when the lens unit or the image capturing section is attached to the camera body. Since each lens unit has different parameters, for instance, a signal processing method of image signals output from the image sensor may differ in each lens unit. Thus, it is very difficult to ensure compatibility between the various types of lens units and the single camera body.

Recent technology developments are advancing at phenomenal speeds. For instance, a high performance CCD requiring a new signal processing method which could not have been anticipated at the time of sales release of the camera body may be developed. In this case, a new lens unit having this new CCD cannot be produced because the data compatibility between the new lens unit and the previously sold camera body cannot be ensured. Therefore, there arises a problem that a new camera body compatible with the new lens unit has to be developed.

### SUMMARY OF THE INVENTION

In view of the foregoing, a primary object of the present invention is to provide a digital camera system in which compatibility between lens units and a camera body is ensured when each lens unit has an image sensor with different imaging properties.

Another object of the present invention is to provide a digital camera system which does not require a camera body to perform different image processing unique to each lens unit.

In order to achieve the above and other objects, the digital camera system of the present invention includes a lens unit having an A/D converter for converting an analog image signal into a digital image signal, a YC processing circuit for converting the digital image signal into YC data, and a lens-side communicating section for transmitting the YC data to the camera body, and a camera body having a camera-side communicating section for receiving the YC data from the lens-side communicating section, a compressing section for compressing the YC data, and an image recording section for recording compressed YC data in a recording medium.

The camera body further includes a thumbnail image generating section which generates a thumbnail image represented by a part of the YC data. The thumbnail image has a smaller pixel size than a principal image represented by the entire YC data.

The image recording section records the compressed YC data in a form of an image file. The image file includes the principal image, the thumbnail image, and tag information which is associated information of the principal image.

The compressing section includes a first compressing section for compressing YC data of a still image, and a second compressing section for compressing YC data of movie images.

The camera body further includes a compression switching section which switches over the first compressing section and the second compressing section in response to a mode switching operation between a still image capture mode and a movie capture mode.

In a preferred embodiment of the present invention, the lens unit includes an A/D converter for converting the analog image signal into digital RAW data, a YC processing circuit for converting the RAW data into YC data, a RAW file creating section for creating a RAW file including the RAW data and information for processing the RAW data, a data format selection section which selects the RAW file in a first mode and the YC data in a second mode, and a lens-side communicating section for transmitting the selected RAW file or YC data to the camera body. The camera body includes a camera-side communicating section for receiving the RAW data or the YC data from the lens-side communicating section, a camera-side compressing section for compressing the YC data, and an image recording section for recording the RAW file or compressed YC data to a recording medium.

The first mode or the second mode is designated by the camera body. The camera body further includes the thumbnail image generating section which generates the thumbnail image represented by a part of the YC data. The thumbnail image has the smaller pixel size than the principal image which is represented by the entire YC data.

The image recording section records the compressed YC data in a form of the image file, the image file includes the principal image, the thumbnail image, and the tag information which is the associated information of the principal image.

In the first mode, the lens communicating section transmits the YC data to the camera body in addition to the RAW file.

It is preferable that the camera body further includes a thumbnail file creating section for creating a thumbnail file which includes the tag information associated to the principal image represented by the entire YC data, and the thumbnail image represented by a part of the YC data and having the smaller pixel size than the principal image. The thumbnail file is recorded in the recording medium by the image recording section in association with the RAW file.

It is preferable that the lens unit further includes a reduced image generating section for generating a simplified display image and the thumbnail image represented by a part of the YC data, a lens-side compressing section for compressing the simplified display image and the thumbnail image, and a simplified display image file creating section for creating a simplified display image file. It is preferable that the simplified display image has a smaller pixel size than the principal image represented by the entire YC data. It is preferable that the thumbnail image has a smaller pixel size than the simplified display image. The simplified display image file constitutes a part of the RAW file, and includes tag information which is associated information of the principal image, a compressed simplified display image, and a compressed thumbnail image.

According to the digital camera system of the present invention, the lens unit converts the captured image signal into the YC data, and transmits the YC data to the camera body. The camera body receives and compresses the YC data, and stores the compressed YC data in the recording medium. The YC data is data of standard color space which does not change before and after the JPEG compression, and independent of CCD types and signal processing types. Therefore, the camera body does not need to perform image processing unique to each lens unit. Thus, the data compatibility is ensured.

The second compressing section for compressing the movie images is provided in the camera body. The first and second compressing sections are changed over in response to the mode changeover operation between the still image capture mode and the movie capture mode. Thereby, in addition to the still image, it becomes possible to compress the movie images, and record the compressed data in the recording medium.

The lens unit creates the RAW file from the captured image signal and transmits the RAW file to the camera body, which simply stores the RAW file in the recording medium. Since the lens-unit dependent RAW file is created in the lens unit, the camera body only has to receive and record the RAW file, without performing different image processing for different lens units. Accordingly, it becomes possible to record the RAW file in the camera body regardless of the combinations of the lens unit and the camera body without any inconvenience.

The RAW file requires much time and effort to process, and a high-speed reproduction thereof consumes some CPU power of a personal computer. Although RAW images have a larger number of pixels than thumbnail images, the RAW file includes additional data for a simplified display image which is smaller than the RAW data. Accordingly, the image in the RAW file can be viewed quickly.

The lens unit transmits the RAW file along with the YC data of the same image. The camera body reduces and compresses the received YC data to generate the thumbnail image, and records the thumbnail image in association with the RAW file in the recording medium. As a result, the thumbnail image is more effectively generated compared to generating the thumbnail image from the RAW file.

### BRIEF DESCRIPTION OF THE DRAWINGS

FIG. 1 is a perspective view of a digital camera system of the present invention;

FIG. 2 is a block diagram of the digital camera system according to a first embodiment of the present invention;

FIG. 3 is a block diagram of a digital signal processing section;

FIG. 4 is an explanatory view of an example of a setup screen;

FIG. 5 is an explanatory view of a still image file compressed in JPEG format;

FIG. 6 is an explanatory view of a RAW file;

FIG. 7 is an explanatory view of a thumbnail file;

FIG. 8 is an explanatory view of a movie file;

FIG. 9 is a flow chart illustrating a sequence of capturing a still image in the first embodiment in which JEPG format is selected for compression;

FIG. 10 is a flow chart illustrating a sequence in the first embodiment when CCD RAW format is selected;

FIG. 11 is a block diagram of the camera system according to a second embodiment;

FIG. 12A is an explanatory view of a RAW file of the second embodiment, and FIG. 12B is an explanatory view of a simplified display image file included in the RAW file; and

FIG. 13 is a flow chart illustrating a sequence in the second embodiment when the CCD RAW format is selected.

### DESCRIPTION OF THE PREFERRED EMBODIMENTS

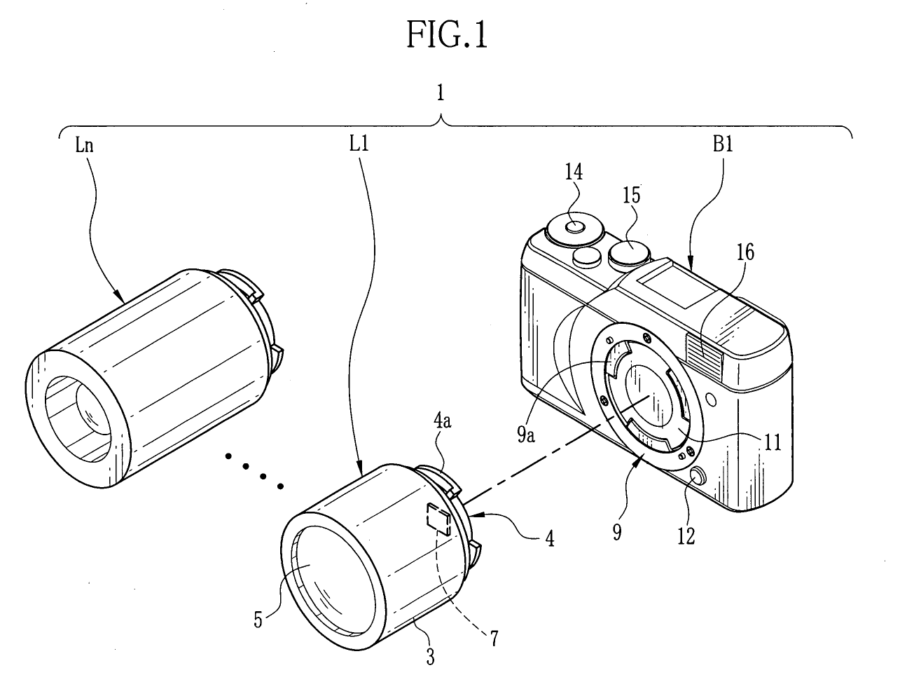

In FIG. 1, a digital camera system 1 is constituted of various types of lens units L1 to Ln (n is a natural number) with different image sensors, and a camera body B1. Each lens unit L1 to Ln has an imaging optical system and an image sensor to generate image signals. One of the lens units L1 to Ln is detachably attached to the camera body B1. The camera body B1 receives the image signals from the attached lens unit, and the received image signals are stored in a memory card and/or displayed on an LCD.

Hereinafter, an example in which the lens unit L1 is attached to the camera body B1 is described. A basic configuration is common to all the lens units L1 to Ln except for configurations of the imaging optical systems and/or CCD properties. Image data transmitted from the lens units L1 to Ln to the camera body B1 is YC data and/or RAW file compatible with the camera body B1.

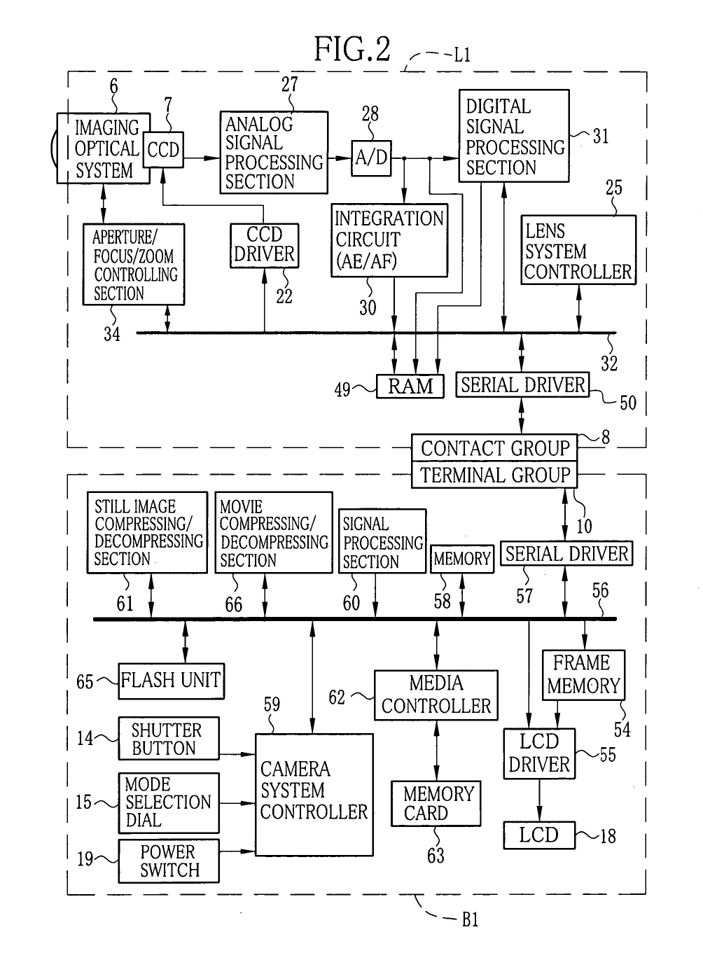

The lens unit L1 includes a lens barrel section 3 and a lens-side mount section 4. The lens barrel section 3 has an imaging optical system 6 including a taking lens 5 (see FIG. 2), a CCD (an image sensor) 7, and a circuit board on which a driving circuit for driving the CCD 7 and a processing circuit for imaging signals output from the CCD 7 are mounted. The imaging optical system 6, the CCD 7, and the circuit board are connected to a contact group 8 provided in the lens-side mount section 4.

The lens-side mount section 4 is constituted of, for instance, three bayonet claws 4a. A front surface of the camera body B1 has a camera-side mount section 9 constituted of three bayonet recesses 9a corresponding to the bayonet claws 4a. The bayonet claws 4a in the lens-side mount section 4 are pushed into the bayonet recesses 9a and rotated. Thereby, the bayonet claws 4a and the bayonet recesses 9a are engaged. At the same time, the contact group 8 (see FIG. 2) comes in contact with a terminal group 10 (see FIG. 2) of the camera-side mount section 9 to electrically connect the lens unit L1 and the camera body B1.

Inside the camera-side mount section 9, a mount lid 11 is provided. The mount lid 11 is biased in a forward direction by a spring and prevents dust from entering the camera body B1 when the lens unit is not attached. A lock release button 12 is provided in the proximity of the camera-side mount section 9. By pressing the lock release button 12, the lock of the lens unit L1 is released, and the lens unit L1 is detached from the camera body B1.

On an upper surface of the camera body B1, a shutter button 14 and a mode selection dial 15 are provided. The shutter button 14 is pressed to capture an image. The mode selection dial 15 is operated to change over a still image capture mode, a movie capture mode, a reproduction mode, and a setup mode. On the front surface of the camera body B1, a flash emitter 16 is provided. On a back surface of the camera body B1, an LCD 18 and a power switch 19 (see FIG. 2) are provided. The LCD 18 displays the captured images and various setting conditions. As well known, the shutter button 14 is pressed in two steps, a half-press and a full press. A switch S1 (not shown) and a switch S2 (not shown) are turned on when the shutter button 14 is half-pressed and fully pressed respectively. The switches S1 and S2 are incorporated in the camera body B1.

In FIG. 2, the imaging optical system 6 includes the taking lens 5, an aperture stop, and the shutter button 14 for adjusting light amount. The subject light is focused on the CCD 7 through the taking lens 5. The CCD 7 is controlled by a lens system controller 25 via a CCD driver 22. The CCD 7 converts the optical subject image into image signals and outputs the image signals.

The image signals are input in an analog signal processing section 27 and subjected to processing for noise reduction and amplification. Thereafter, the image signals are converted into digital image signals (RGB RAW data) by an A/D converter 28. Hereinafter, the camera system 1 in the still image capture mode is described.

The image signals are supplied to an integration circuit 30 and a digital signal processing section 31. The integration circuit 30 measures subject brightness (for AE) and subject distance (for AF). The measured data is sent to an aperture/focus/zoom controlling section 34 via a data bus 32. The aperture/focus/zoom controlling section 34 adjusts the aperture, focus, and zooming of the imaging optical system 6.

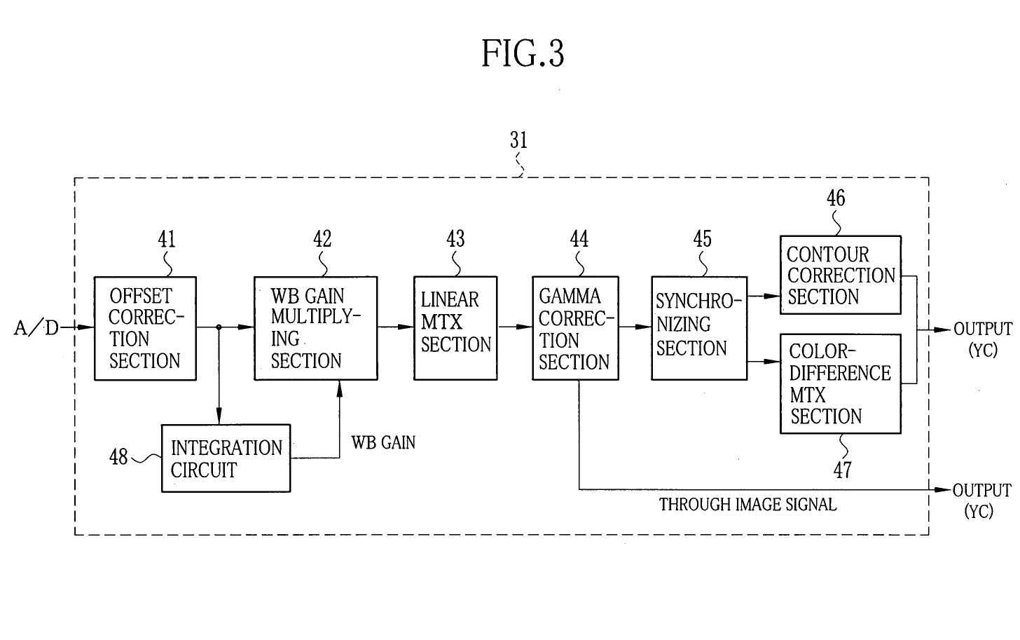

The image signals input in the digital signal processing section 31 are subjected to image processing which is described in the following with referring to FIG. 3. The digital signal processing section 31 is constituted of an offset correction section 41, a white balance gain (WB gain) multiplying section 42, a linear matrix (MTX) section 43, a gamma correction section 44, a synchronizing section 45, a contour correction section 46, a color difference matrix (MTX) section 47, and an integration circuit 48.

When the image signals are for a through image display, the image signals are transmitted to the offset correction section 41 in which a dynamic range is adjusted, the WB gain multiplying section 42 in which each gain of the R, G, and B signals is adjusted to obtain a white color with high purity, the linear MTX section 43 in which the image signals are converted into YCrCb signals, and the gamma correction section 44 in which the brightness is adjusted, and then converted into YC data. The YC data is sent to a serial driver 50 (see FIG. 2) via the data bus 32. The serial driver 50 converts the YC data into serial signals and sends the serial signals to the camera body B1 via the contact group 8 and the terminal group 10. The YC data is converted into parallel signals in a serial driver 57 and written in a frame memory 54 via a data bus 56. Then the through images based on the YC data stored in the frame memory 54 are displayed on the LCD 18 via an LCD driver 55. The frame memory 54 has two memory areas each for one frame: the through image is read from one memory area while next through image is written in the other memory area. The integration circuit 48 integrates the R, G, and B components of the image signals output from the offset correction section 41 to obtain each gain, and sends the gains to the WB gain multiplying section 42.

In the WB gain multiplying section 42 and the integration circuit 48, the number of pixels designated in the setup mode is set as a parameter. The setup mode will be described later. In the linear MTX section 43, matrix coefficients for color conversion are set as parameters in accordance with tone and saturation settings. In the contour correction section 46, matrix coefficients for edge enhancement are set as parameters in accordance with a sharpness setting.

The YC data is an 8 bit data based on standard color space which does not change before and after JPEG compression. The YC data is independent of CCD types and signal processing types. For this reason, it is not necessary for the camera body B1 to perform different processing for each of the lens units L1 to Ln. Thus, data compatibility is secured.

When the shutter button 14 is fully pressed, the signals output from the CCD 7 are processed and transmitted to the gamma correction section 44 of the digital signal processing section 31 as with the signals for a through image, and thus the YC data is generated. The YC data is synchronized in the synchronizing section 45. Then, the Y signal component is supplied to the contour correction section 46, and the color signal (C signal) component is supplied to the color difference MTX section 47.

In the contour correction section 46, the Y signal is subjected to the edge enhancement. In the color difference MTX section 47, the C signal is converted into the color difference signal. The Y signal and the color difference signal (YC data) are temporarily stored in the RAM 49. Thereafter, the YC data is sent to the camera body B1 via the contact group 8 and the terminal group 10. The YC data is written in a memory (SDRAM) 58 via a serial driver 57 of the camera body B1.

A camera system controller 59 reads the YC data from the memory 58, and performs resizing and electronic zoom processing to the YC data in a signal processing section 60, and then compresses the YC data (for instance, in JPEG format) in a still image compressing/decompressing section 61, and writes the compressed data in a removable memory card 63 via a media controller 62.

When the shutter button 14 is fully pressed, a flash unit 65 is activated in accordance with the brightness of a scene, and flash light is emitted by the flash emitter 16 to the subject. The flash emitter 16 is included in the flash unit 65. The camera system controller 59 issues commands to the lens system controller 25 in response to the operation signals from the shutter button 14, the mode selection dial 15, and the power switch 19 that are connected to the system controller 59, and controls the recording processing in the camera body B1.

To capture a movie, the mode selection dial 15 is set to the movie capture mode. Thereafter, the shutter button 14 is pressed. Movie image signals are converted into the YC data and sent from the lens unit L1 to the camera body B1 in the same manner as the above still image signals, and then temporarily stored in the memory 58. Thereafter, the camera system controller 59 reads the YC data from the memory 58, and compresses the YC data (for instance, in MPEG-2 format) in a movie compressing/decompressing section 66, and then writes the YC data in the memory card 63 via the media controller 62.

Thus, both the still image signals and the movie image signals are converted into YC data which has high compatibility, and sent from the lens unit L1 to the camera body B1. In other words, since all image signals captured by the lens units L1 to Ln are sent to the camera body B1 after being converted into YC data, the camera body B1 is able to store the YC data in the memory card 63 and display the image in the LCD 18 no matter which lens unit is attached.

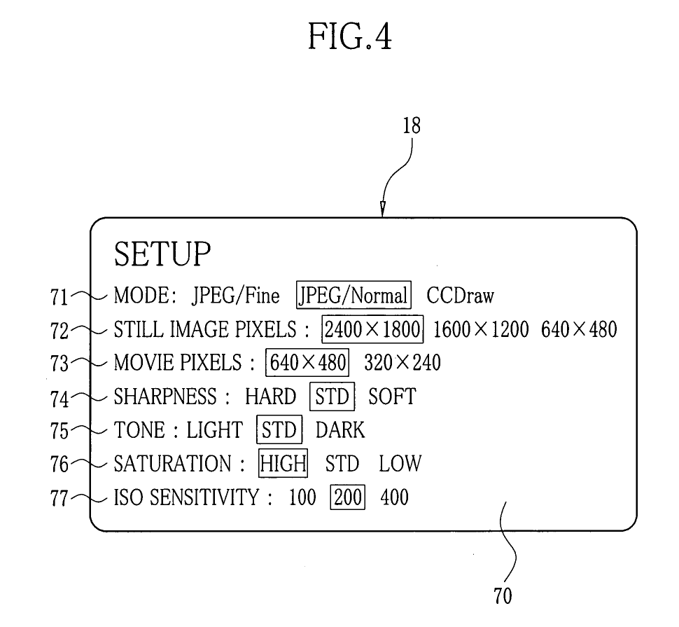

When the mode selection dial 15 is set to the setup mode, a setup screen 70 is displayed as shown in FIG. 4 for various settings. In the setup screen 70, selection items, specifically, a recording mode 71, number of still image pixels 72, number of movie pixels 73, sharpness 74, tone 75, saturation 76, and ISO sensitivity 77 are displayed in this order.

For instance, either a JPEG Normal mode with data compression rate of 2 bit/pel, a JPEG Fine mode with data compression rate of 4 bit/pel, or a CCD RAW mode can be selected in the recording mode. When the JPEG mode is selected, the image data is converted into the YC data in the lens unit L1 as described above, and then the YC data is compressed in JPEG format in the camera body B1. The compressed data is stored in the memory card 63.

When the CCD RAW mode is selected, the RAW data output from the A/D converter 28 of the lens unit L1 is stored in the RAM 49. The stored RAW data is then combined with a header, tag information, and processing parameters to constitute a RAW file. The RAW file is sent to the camera body B1 via the serial driver 50, and directly stored in the memory card 63. That is, the camera body B1 does not need to perform the processing unique to the lens unit L1, and the compatibility of the RAW data is secured as with the YC data. A thumbnail image of the RAW data is generated in the camera body B1, and stored in the memory card 63 in association with the RAW file.

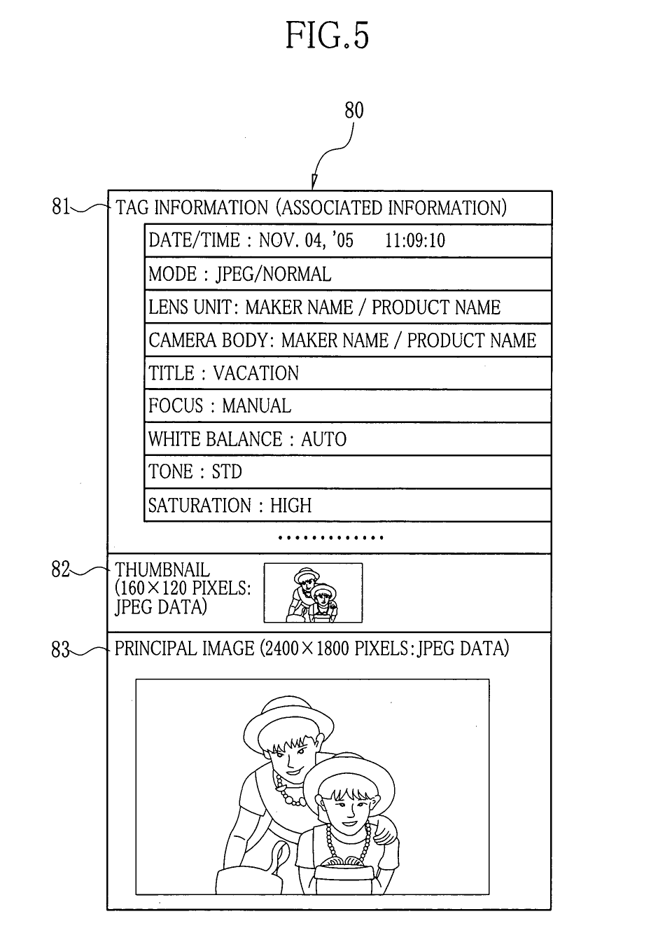

In FIG. 5, a still image file 80 includes tag information 81, a thumbnail image 82, and a principal image 83. The tag information 81 is image-associated information, and includes image capture date, model names, image capture settings, and the like. Since the present invention is the digital camera system having the exchangeable lens units, the model names include maker names and product names of both the lens unit (a main image capture device) and the camera body (a sub image capture device).

Most of the contents in the tag information 81 are automatically generated in the lens unit L1 at the time of image capturing. For this reason, the lens system controller 25 of the lens-unit L1 generates the tag information 81. The image capture date, however, is sent from the camera body B1 to the lens unit L1 at the time of image capturing since the camera body B1 has a calendar IC. The camera body B1 also sends the data which will not be changed after the lens unit L1 is activated, such as the model name of the camera body, to the lens unit L1. It is also possible for the lens unit L1 to create the still image file 80, leaving the items obtained only in the camera body B1 blank. The camera body B1 can fill in the blanks before storing the still image file 80 in the memory card 63.

The thumbnail image 82 is JPEG still image data with an image size of 160×120 pixels. The pixel number of the thumbnail image 82 is constant regardless of that of the principal image 83. The thumbnail image 82 is generated in the camera body B1 by resizing the YC data for the principal image 83, and compressing the resized data in JPEG format. The principal image 83 is generated by resizing the YC data which is generated in the lens unit L1, and compressing the resized data in JPEG format. The pixel number of the principal image 83 is designated by the user, for instance, JPEG compressed data of 2400×1800 pixels. The camera system controller 59 decompresses the tag information 81, the thumbnail image 82, and the principal image 83 in the memory 58 as the image file and stores the image file in the memory card 63.

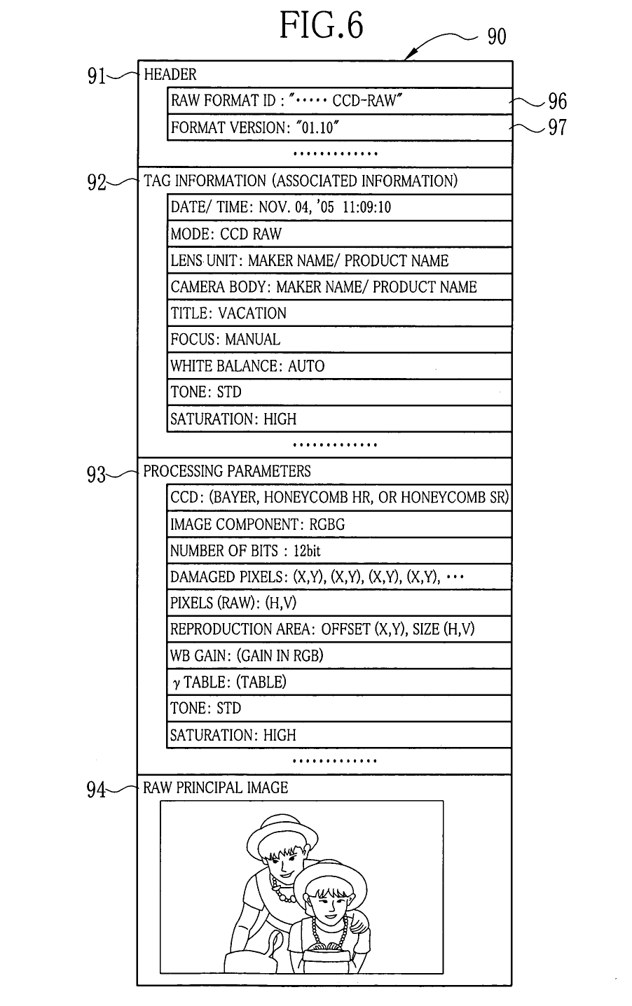

In FIG. 6, a RAW file 90 includes a header 91, tag information 92, processing parameters 93, and a RAW principal image 94. The header includes specification information 96 of the RAW file 90 and its version information 97.

The tag information 92 is similar to the tag information 81, and thus the description of the tag information 92 is omitted. The processing parameters 93 are used for processing the RAW file 90, that is, for converting the RAW file 90 into YC data. The processing parameters include the CCD type, the number of bits, damaged data, the number of pixels of RAW principal image, an offset amount and a size of the image reproduction area, and the image capture settings such as tone, saturation, and WB setting. The RAW principal image 94 is RAW image data which has been subjected to the A/D conversion.

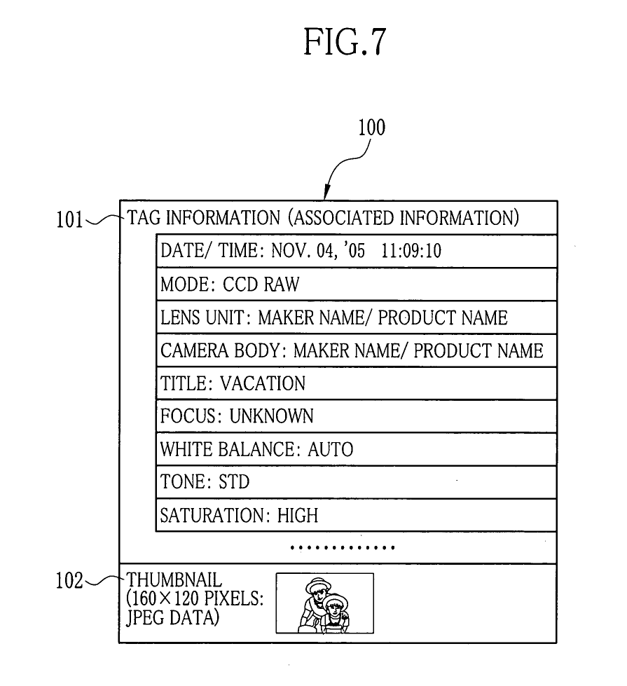

At the time of creating the RAW file 90, a thumbnail file 100 (see FIG. 7) is created in the camera body B1, and stored in the memory card 63 in association with the RAW file 90. The YC data necessary for creating the thumbnail file 100 is generated through the signal processing in the lens unit L1, and sent to the camera body B1 in the same manner as in the JPEG mode. The still image compressing/decompressing section 61 resizes and compresses the YC data in JPEG format, and thus a thumbnail image 102 is generated. Note that the thumbnail file 100 also has tag information 101. The tag information 101 only includes the information that the camera body B1 holds. Information such as the maker name and the product name of the lens unit L1 is sent from the lens unit L1 to the memory 58 of the camera body B1 when the lens unit L1 is activated.

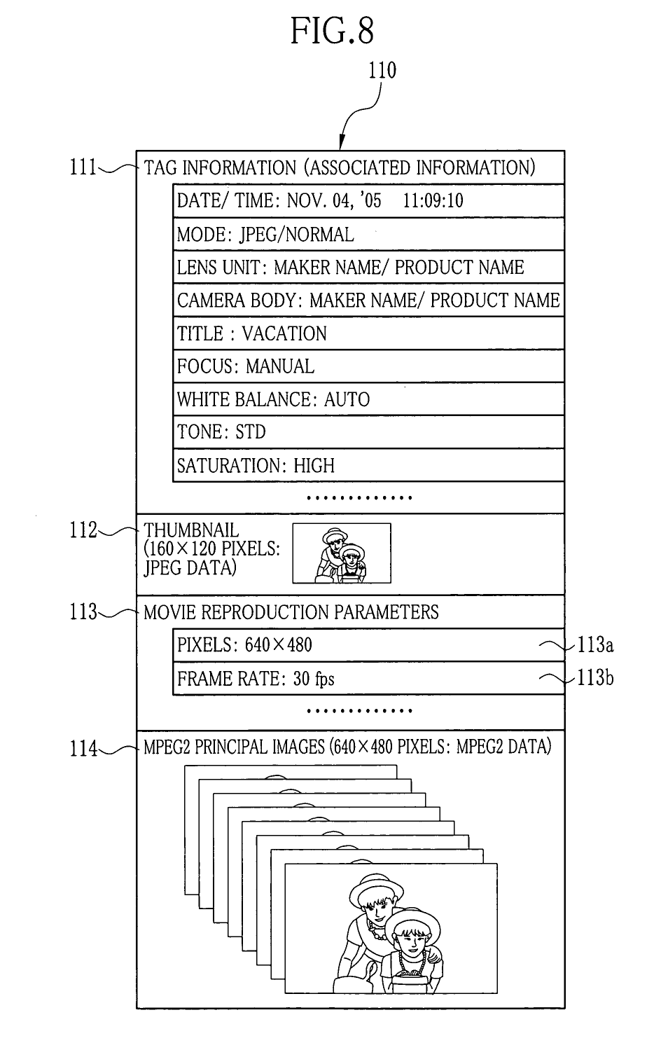

In FIG. 8, a movie file 110 includes tag information 111, a thumbnail image 112, movie reproduction parameters 113 and an MPEG-2 principal image 114. The tag information 111, and the thumbnail image 112 are similar to those in the still image file 80. The movie reproduction parameters 113 include parameters necessary for reproducing the movie such as number of pixels 113a and a frame rate 113b. In this embodiment, the frame rate 113b is fixed at 30 frames per second (fps). The number of movie pixels can be selected from VGA (640×480) and QVGA (320×240) in the setup screen 70. The MPEG-2 principal image 114 is the image data compressed in MPEG-2 format.

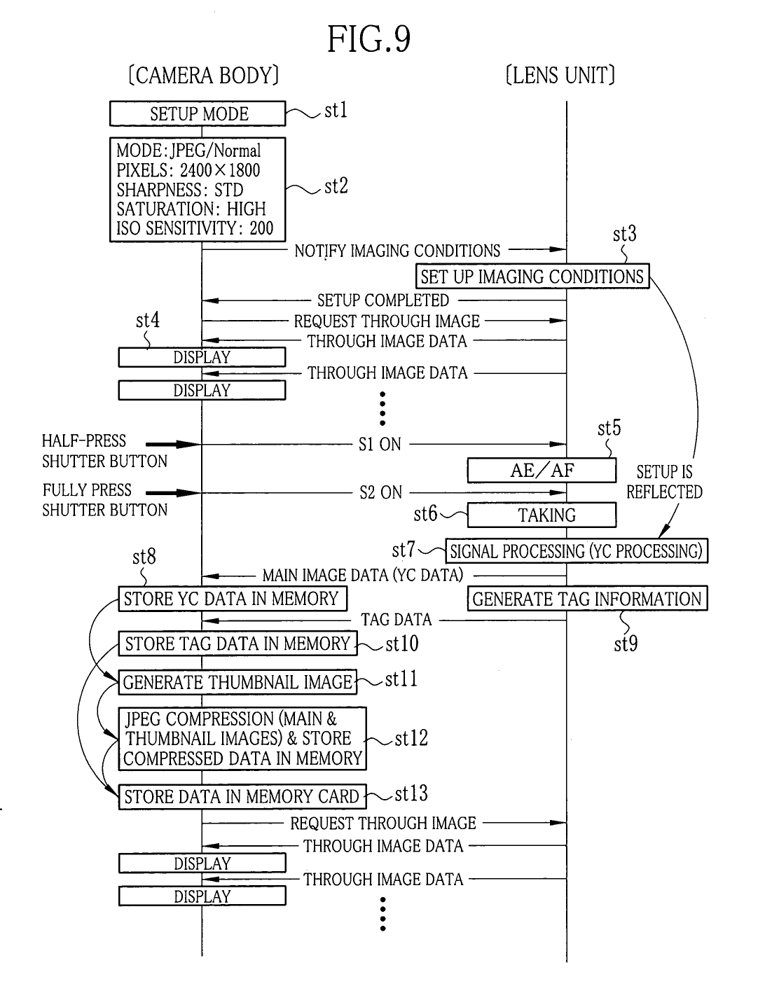

To capture a still image by the camera system 1 of the first embodiment configured as above, as shown in a flowchart of FIG. 9, the setup mode is firstly selected by operating the mode selection dial 15 (st 1) to display the setup screen 70 as shown in FIG. 4. Then, the items on the screen 70 are set up as follows (st 2): the recording mode 71 at JPEG Normal mode, the number of pixels 72 at 2400×1800, the number of movie pixels 73 at 640×480, the sharpness 74 at standard, the tone 75 at standard, the saturation 76 at high, and the ISO sensitivity 77 at 200.

The above settings are sent from the lens unit L1 to the camera body B1 via the terminal group 10 and the contact group 8, and set in the digital signal processing section 31 (st 3). When a set completion signal of the digital signal processing section 31 is sent from the lens system controller 25 to the camera system controller 59, the through image request signal is sent from the camera system controller 59 to the lens system controller 25.

The image signal photoelectrically converted in the CCD 7 is converted into YC data through the processing from the A/D converter 28 to the gamma correction section 44 of the digital signal processing section 31. The YC data is temporarily stored in the RAM 49, and then sent by the serial driver 50 to the frame memory 54 via the contact group 8 and the terminal group 10. The YC data is read from the frame memory 54 at 30 fps, and displayed in the LCD 18 as the through image via the LCD driver 55 (st 4).

Framing is determined while viewing the LCD 18. When the shutter button 14 is half pressed, the switch S1 is turned on. Thereby, the integration circuit 30 measures the subject brightness and the subject distance based on the image signal captured concurrently with the turning-on of the S1 switch. The measured data for the AE and AF is sent to the aperture/focus/zoom control section 34 via the data bus 32 (st 5).

When the shutter button 14 is fully pressed, the S2 switch is turned on (st 6). At this instant, the captured image signal is output from the digital signal processing section 31 as YC data after the synchronization and the contour correction (st 7). The YC data is temporarily stored in the RAM 49, and then written in the memory 58 via the contact group 8, terminal group 10, and the data bus 56 (st 8).

The tag information 81 including the image capture date, model names, and the image capture settings is generated in the lens system controller 25 (st 9), and sent to the camera body B1, and then stored in the memory 58 (st 10). The camera system controller 59 reads the YC data from the memory 58, and the thumbnail image 82 is generated by resizing the YC data in the signal processing section 60 (st 11). The camera system controller 59 compresses the thumbnail image 82 and the unresized principal image 83 in JPEG format in the still image compressing/decompressing section 61 to generate the thumbnail image 82 with an image size of 160×120 pixels and the principal image of 2400×1800 pixels (st 12). The thumbnail image 82, the principal image 83, and the tag information 81 are written in the memory card 63 as an image file via a media controller 62 (st 13).

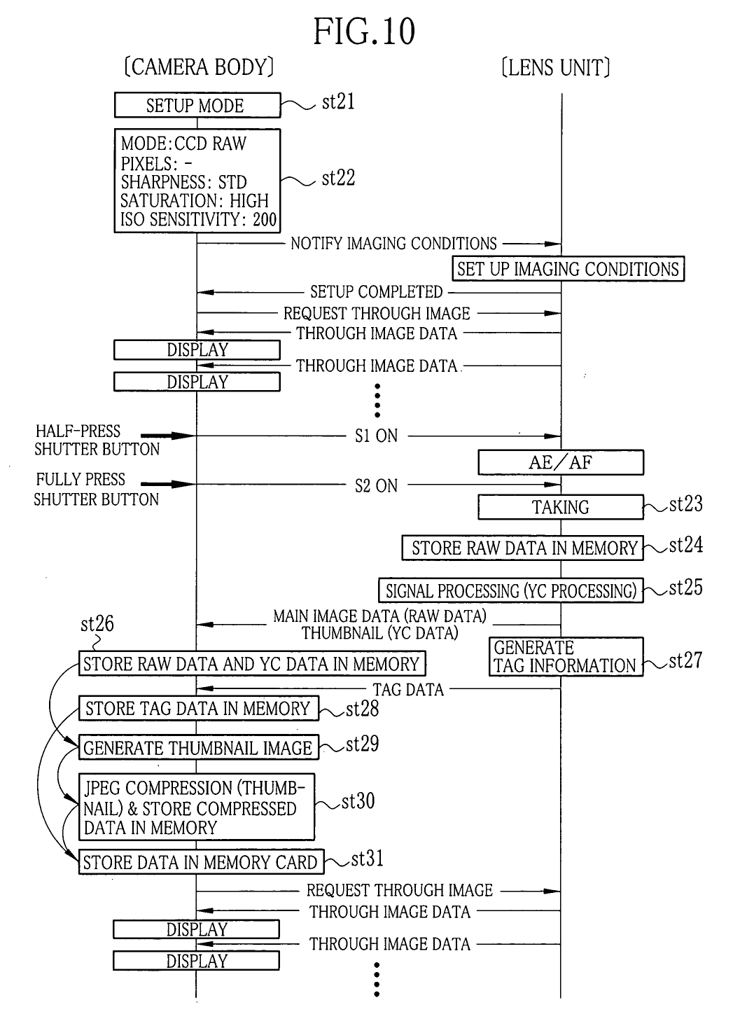

Alternatively, as shown in FIG. 10, in the setup mode (st 21), the CCD RAW mode is selected for the recording mode (st 22), and the image is captured (st 23). In this case, the RAW data is output from the A/D converter 28 and stored in the RAM 49 (st 24). The RAW data is also converted into YC data for generating the thumbnail image by the digital signal processing section 31 (st 25). The YC data and the raw data are written in the memory 58 via the contact group 8 and the terminal group 10 (st 26).

The tag information 92 (st 27) generated in the lens system controller 25 is sent to the camera body B1, and written in the momory 58 (st 28). The camera system controller 59 reads the YC data from the memory 58, and the thumbnail image 102 of 160×120 pixels is generated by resizing in the signal processing section 60 (st 29). Then, the thumbnail image 102 is compressed in JPEG format by the still image compressing/decompressing section 61 (st 30). The thumbnail image 102 is combined with the tag information 101 obtained in the camera body B1 and constitutes the thumbnail file 100.

The RAW file 90 is created by adding the tag information 92, the header 91, and processing parameters 93 to the RAW data. The RAW file 90 and the thumbnail file 100 are associated and written in the memory card 63 via the media controller 62 (st 31).

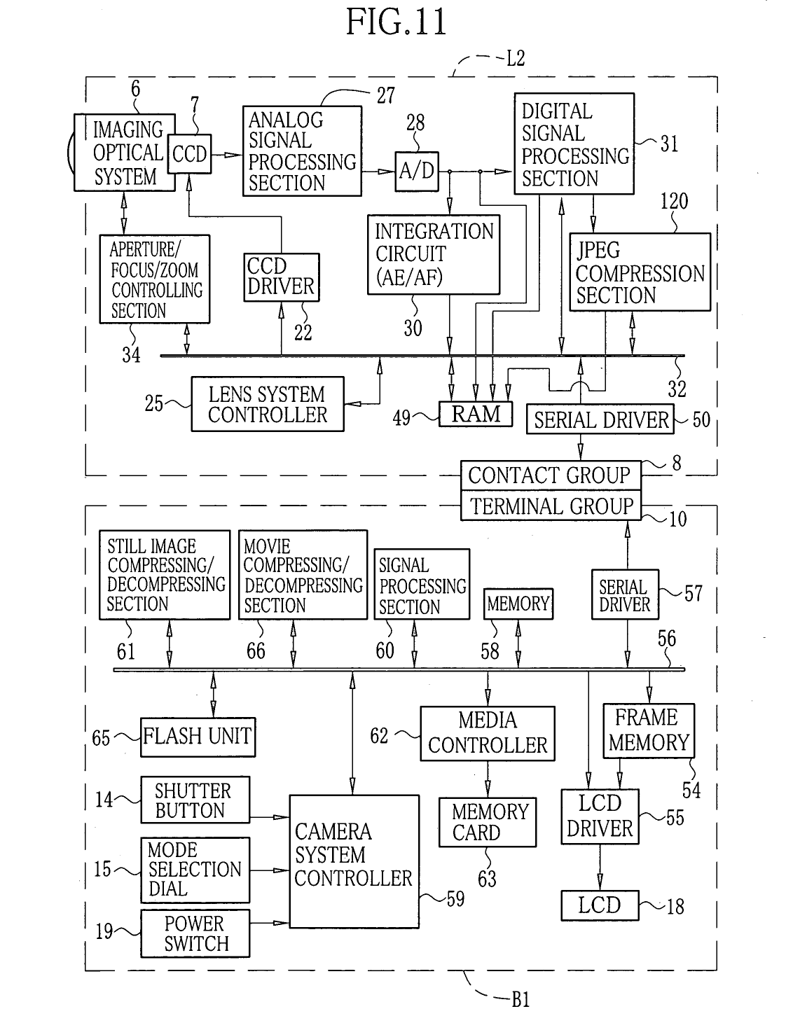

Next, a second embodiment of the present invention is described. The same numeral denotes the same member as in the above first embodiment, and the description thereof is omitted. As shown in FIG. 11, a lens unit L2 is much the same as the lens unit L1 but has a JPEG compression section 120. When the CCD RAW mode is selected, the JPEG compression section 120 generates simplified display image data by compressing the YC data which is resized and output from the digital signal processing section 31, and stores this compressed simplified display image data in the RAM 49.

The simplified display image data is a megapixel image with an image size of 1280×960 pixels, which is larger than a normal thumbnail image of 160×120 pixels. Therefore, the simplified display image in the RAW file can be clearly identified. However, the simplified display image data has smaller data size than the RAW file, and thus the entire size of the RAW file is not affected.

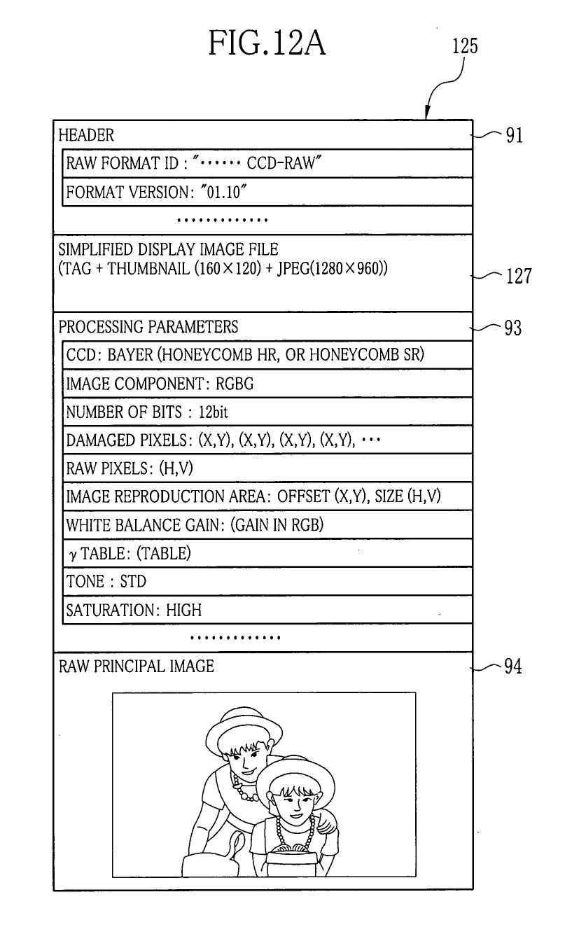

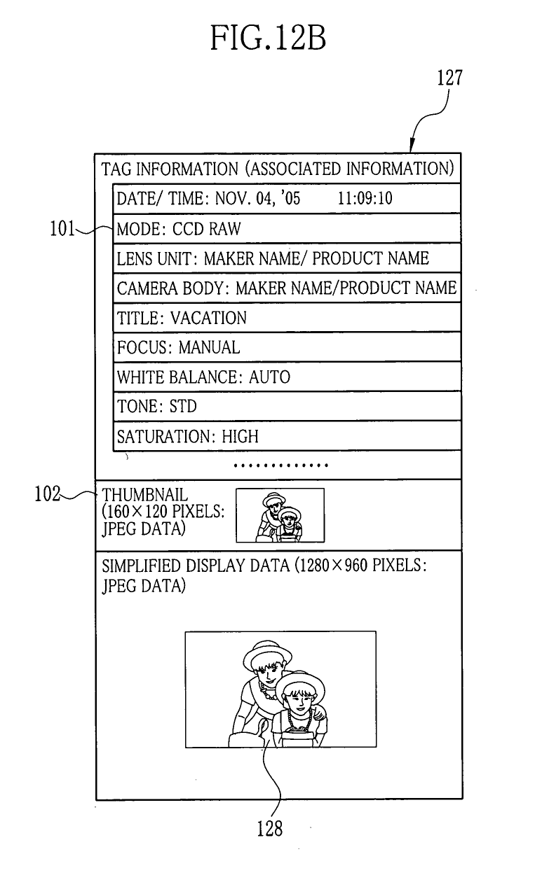

As shown in FIGS. 12A and 12B, a simplified display image 128 stored in the RAM 49 constitutes a simplified display image file 127 together with the tag information 101 generated by the lens system controller 25, and the thumbnail image 102 compressed in the JPEG compression section 120. The simplified display image file 127 is integrated in the RAW file 125.

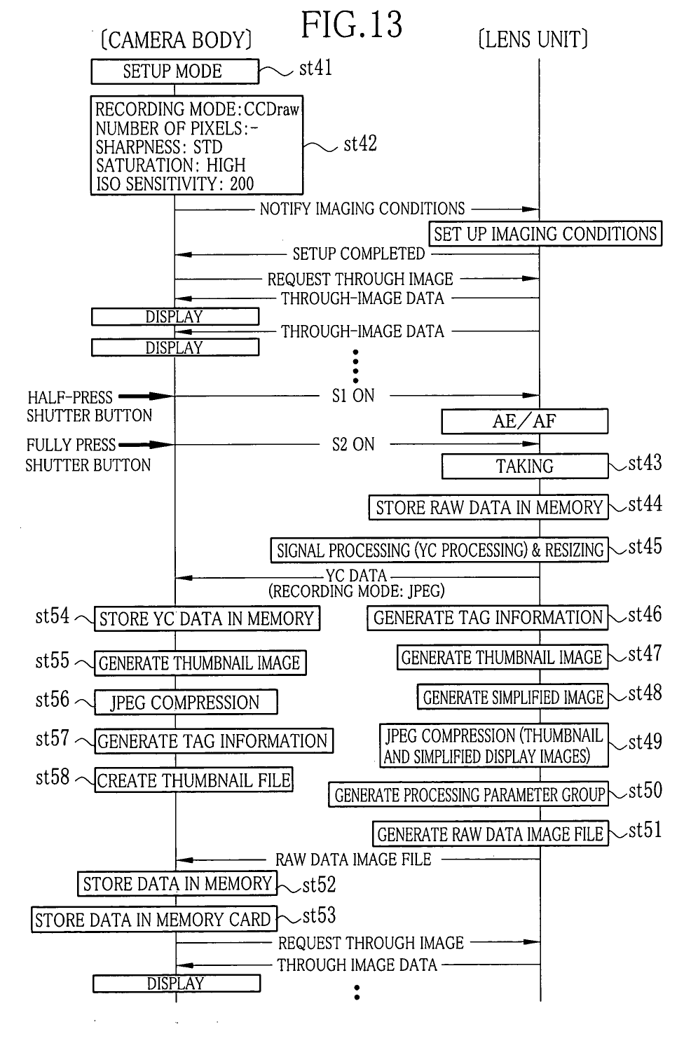

As shown in FIG. 13, when in the setup mode (st 41), the CCD RAW is selected (st 42), and then an image is captured (st 43). The RAW data output from the A/D converter 28 is stored in the RAM 49 (st 44). The RAW data is also converted into YC data and resized in the digital signal processing section 31 (st 45). The YC data is temporarily stored in the RAM 49.

The lens system controller 25 generates the tag information 101 (st 46). The digital signal processing section 31 resizes the YC data to generate the thumbnail image 102 (st 47) and the simplified display image 128 (st 48). The thumbnail image 102, and the simplified display image 128 are compressed in the JPEG compression section 120 (st 49). The lens system controller 25 generates the processing parameters 93 according to the type of the CCD 7 and the like (st 50).

The lens system controller 25 creates the simplified display image file 127 from the tag information 101, the thumbnail image 102, and the simplified display image 128. The simplified display image file 127, the header 91, the processing parameters 93, and the RAW principal image 94 are decompressed as an image file in the RAM 49 (st 51) by the lens system controller 25, and sent to the camera body B1.

In the camera body B1, the image file (the RAW file 125) is temporarily stored in the memory 58 (st 52), and then stored in the memory card (st 53). Note that the steps from the st 54 to the st 58 are executed in the JPEG mode and the same as in the first embodiment, and thus the description of these steps is omitted.

In the above embodiments, the thumbnail images have a size of 160×120 pixels, and simplified display images have a size of 1280×960 pixels. However, the number of the pixels is not limited to the above. In the above embodiments, a digital camera is used as the digital camera system. However, the present invention is not limited to the above. It is also possible to use a mobile phone with a camera or a movie camera as the digital camera system.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A digital camera system constituted of a lens unit having an image sensor for photoelectrically converting an optical image focused by a taking lens and outputting an analog image signal, and a camera body to which said lens unit is detachably attached, said digital camera system comprising:
(A) said lens unit including:
an A/D converter for converting said analog image signal into a digital image signal,
a YC processing circuit for converting said digital image signal into YC data; and
a lens-side communicating section for transmitting said YC data to said camera body;
(B) said camera body including:
a camera-side communicating section for receiving said YC data from said lens-side communicating section;
a compressing section for compressing said YC data; and
an image recording section for recording compressed YC data in a recording medium.

2. A digital camera system according to claim 1, wherein said camera body further includes a thumbnail image generating section which generates a thumbnail image represented by a part of said YC data, and said thumbnail image has a smaller pixel size than a principal image represented by said entire YC data.

3. A digital camera system according to claim 2, wherein said image recording section records said compressed YC data in a form of an image file, and said image file includes said principal image, said thumbnail image, and tag information which is associated information of said principal image.

4. A digital camera system according to claim 3, wherein said compressing section includes a first compressing section for compressing YC data of a still image, and a second compressing section for compressing YC data of movie images.

5. A digital camera system according to claim 4, wherein said camera body further includes a compression switching section which switches over said first compressing section and said second compressing section in response to a mode switching operation between a still image capture mode and a movie capture mode.

6. A digital camera system constituted of a lens unit having an image sensor for photoelectrically converting an optical image focused by a taking lens and outputting an analog image signal, and a camera body to which said lens unit is detachably attached, said digital camera system comprising:
(A) said lens unit including:
an A/D converter for converting said analog image signal into digital RAW data;
a YC processing circuit for converting said RAW data into YC data;
a RAW file creating section for creating a RAW file including said RAW data and information for processing said RAW data;
a data format selection section which selects said RAW file in a first mode, and said YC data in a second mode; and
a lens-side communicating section for transmitting said selected RAW file or YC data to said camera body;
(B) said camera body including:
a camera-side communicating section for receiving said RAW file or said YC data from said lens-side communicating section;
a camera-side compressing section for compressing said YC data; and
an image recording section for recording said RAW file or compressed YC data in a recording medium.

7. A digital camera system according to claim 6, wherein said first mode or said second mode is designated by said camera body.

8. A digital camera system according to claim 7, wherein said camera body further includes a thumbnail image generating section which generates a thumbnail image represented by a part of said YC data, and said thumbnail image has a smaller pixel size than a principal image which is represented by said entire YC data.

9. A digital camera system according to claim 8, wherein said image recording section records said compressed YC data in a form of an image file, and said image file includes said principal image, said thumbnail image, and tag information which is associated information of said principal image.

10. A digital camera system according to claim 6, wherein in said first mode, said lens communicating section transmits said YC data to said camera body in addition to said RAW file.

11. A digital camera system according to claim 10, wherein said camera body further includes a thumbnail file creating section for creating a thumbnail file which includes tag information associated to a principal image represented by said entire YC data, and a thumbnail image represented by a part of said YC data and having a smaller pixel size than said principal image, and said thumbnail file is recorded in said recording medium by said image recording section in association with said RAW file.

12. A digital camera system according to claim 6, wherein said lens unit further including:
a reduced image generating section for generating a simplified display image and a thumbnail image represented by a part of said YC data, said simplified display image having a smaller pixel size than a principal image represented by said entire YC data, said thumbnail image having a smaller pixel size than said simplified display image;
a lens-side compressing section for compressing said simplified display image and said thumbnail image; and
a simplified display image file creating section for creating a simplified display image file, said simplified display image file constituting a part of said RAW file, and including tag information which is associated information of said principal image, a compressed simplified display image, and a compressed thumbnail image.
